(19) United States
(12) Patent Application Publication
(10) Pub. No.: US 2006/0242183 A1
(43) Pub. Date: Oct. 26, 2006

(54) Declaratively extended hierarchical configuration system and method

(75) Inventors: Shanku S. Niyogi, Bellevue, WA (US); Adam W. Smith, Lexington, MA (US); Peter J. Russo, Seattle, WA (US); Rederic R. Videna, Seattle, WA (US); Rodney A. Korn, Woodinville, WA (US); Shai Kariv, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/114,333

(22) Filed: Apr. 25, 2005

(51) Int. Cl. G06F 17/00

(52) U.S. Cl. 707/101

(57) ABSTRACT

A configuration system is organized with a configuration file for each node in an application hierarchy. Each configuration file includes one or more directives for applying a configuration setting to a node. Each configuration setting is associated with one or more objects that define properties of the configuration setting. The properties define rules for the configuration setting such as inheritance, persistence, validation, merging, and the like. Defining rules for each configuration setting in an object allows the configuration settings to be declaratively extended and edited without requiring user to have knowledge of the underlying hierarchy.

### BACKGROUND OF THE INVENTION

Configurability is a key scenario for most modern computer systems and applications, and an easily manageable and extensible configuration system is an important element of a robust system.

To enable configuration and management of complex applications, configuration systems often arrange configuration settings into a logical hierarchy corresponding to a hierarchy defined by the application. Configuration settings can then be set at each node, and well-known concepts of inheritance and overrides can then be used to control how these settings are applied to other nodes.

Although this kind of configuration system is common, most of these systems are very difficult to extend in a well-behaved, schematized, way. Some hierarchical configuration systems have no concept of schematization, and allow arbitrary loosely defined settings to be stored for each node. Other hierarchical systems offer a schema, but the schema only defines what can be set at each node. In all these cases, an application or management tool that inspects configuration settings must manually look at each node and validate it, and then apply inheritance rules as a separate step. Thus, to extend such a system with a new group of settings, a developer must either write significant extra code to manually merge and validate settings across nodes, or provide no clear merge semantics, shifting the burden of understanding and applying inheritance behavior to the individual reading or writing those settings.

### SUMMARY OF THE INVENTION

Embodiments of the present invention relate to a declaratively extended hierarchal configuration system and method that provides for declarative serialization of configuration settings. Declarative serialization allows a developer to declaratively control how an object is persisted. The developer may create an object type and annotate each object with a set of serialization rules, and the system may then use rules to control serialization. Applied to the configuration settings of the present invention, the developer is able to automatically control persistence, inheritance, validation, default values, and behavior rules for complex collections of settings. With these declarative attributes, a developer may extend the configuration system using a well-understood object type, and for a consumer of that object type to use it while being fully insulated from the underlying details of the configuration hierarchy. The resulting configuration system is therefore more easily understood and extended.

In accordance with one aspect of the present invention, a computer-implemented method provides a hierarchical configuration system. The system associates a schema with a configuration hierarchy. The configuration hierarchy corresponds to configuration settings applied to an application hierarchy. The system associates an object type in the schema with a configuration setting of the configuration hierarchy. The object type declaratively defines a set of properties applicable to the configuration setting. The system transparently applies the configuration settings to the application hierarchy in accordance with the set of properties declaratively defined in the object type.

In accordance with another aspect of the invention, a hierarchical configuration system includes a computing device and a memory. The memory having stored thereon data structures for implementing the configuration system. The data structures include an application hierarchy, configuration files, and a schema. The application hierarchy provides a logical inheritance relationship among applications and components. The configuration files correspond to each node of the application hierarchy. The configuration files include directives for applying configuration settings to the application hierarchy. The schema includes object types corresponding to the directives of the configuration files. An object type in the schema is associated with a configuration setting of the configuration hierarchy. The object type declaratively defines a set of properties applicable to the configuration setting such that the configuration settings are transparently applied to the application hierarchy in accordance with the set of properties.

### BRIEF DESCRIPTION OF THE DRAWINGS

FIG. 1 illustrates a computing device that may be used according to an example embodiment.

FIG. 2 illustrates an exemplary application hierarchy to which the configuration system of the present invention may be applied.

FIG. 3 illustrates portions of exemplary configuration files associated with an application hierarchy in accordance with the present invention.

FIG. 4 illustrates another example of portions of exemplary configuration files associated with an application hierarchy in accordance with the present invention.

FIG. 5 illustrates an exemplary schema that defines a collection in accordance with the present invention.

FIG. 6 illustrates portions of additional exemplary configuration files associated with an application hierarchy in accordance with the present invention.

FIG. 7 is a logic flow diagram illustrating an exemplary process for declaratively extending a configuration setting in accordance with the present invention.

FIG. 8 is a logic flow diagram illustrating an exemplary process for modifying configuration settings in accordance with the present invention.

### DETAILED DESCRIPTION

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

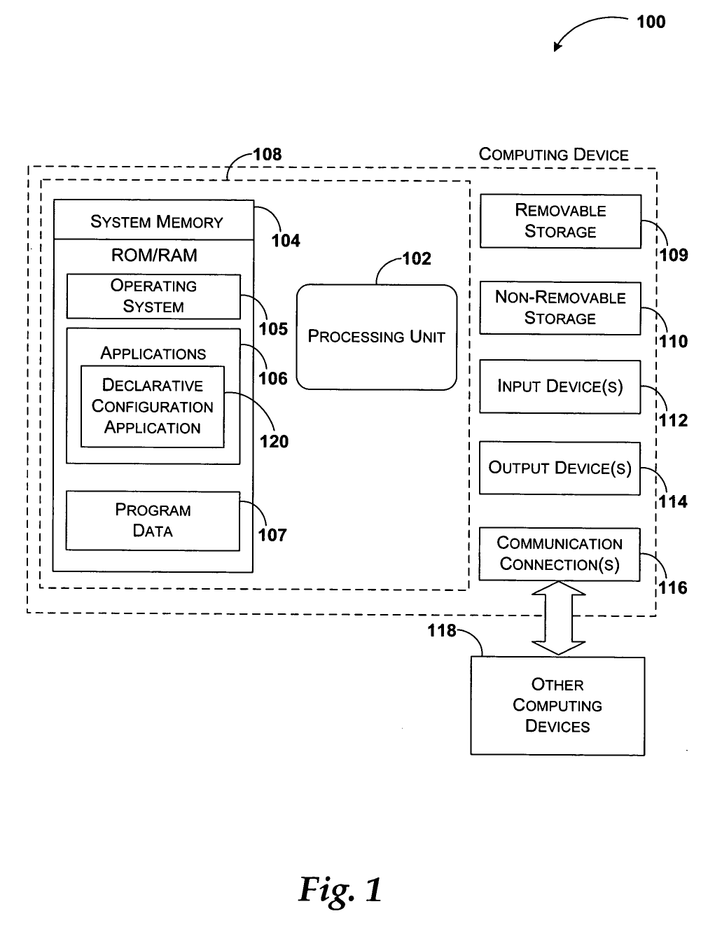

Referring to FIG. 1, an example system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes an operating system 105, one or more applications 106, and may include program data 107. This basic configuration is illustrated in FIG. 1 by those components within dashed line 108. In one embodiment, applications 106 include declarative configuration application 120 for implementing the functionality of the present invention.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. All these devices are known in the art and need not be discussed at length here.

Computing device 100 also contains communications connection(s) 116 that allow the device to communicate with other computing devices 118, such as over a network or a wireless mesh network. Communications connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Illustrative Declaratively Extended Hierarchical Configuration System

Embodiments of the present invention are related to providing a hierarchical configuration system that allows a user to declaratively extend the configuration settings of the system. The present invention defines a schema for the hierarchy. The schema defines object types that correspond to various configuration settings of the hierarchy. Properties of the configuration setting may be declaratively included in the associate object type so that user may make changes to the configuration using the object. A user of the hierarchy that desires to change a configuration setting may therefore declaratively change the setting despite not having knowledge of the underlying structure of the hierarchy. The configuration system may then apply the configuration changes according to the rules and properties of the associated object type. The changes are applied while automatically accounting for persistence, inheritance, validation, and collection semantics associated with the changed code.

The terms “user”, “developer”, and “client” are used interchangeably throughout the following specification and the claims to denote an entity that utilizes the functionality of the present invention. The invention should therefore no be considered limited to use by a particular entity, a particular hardware platform, or a particular software application.

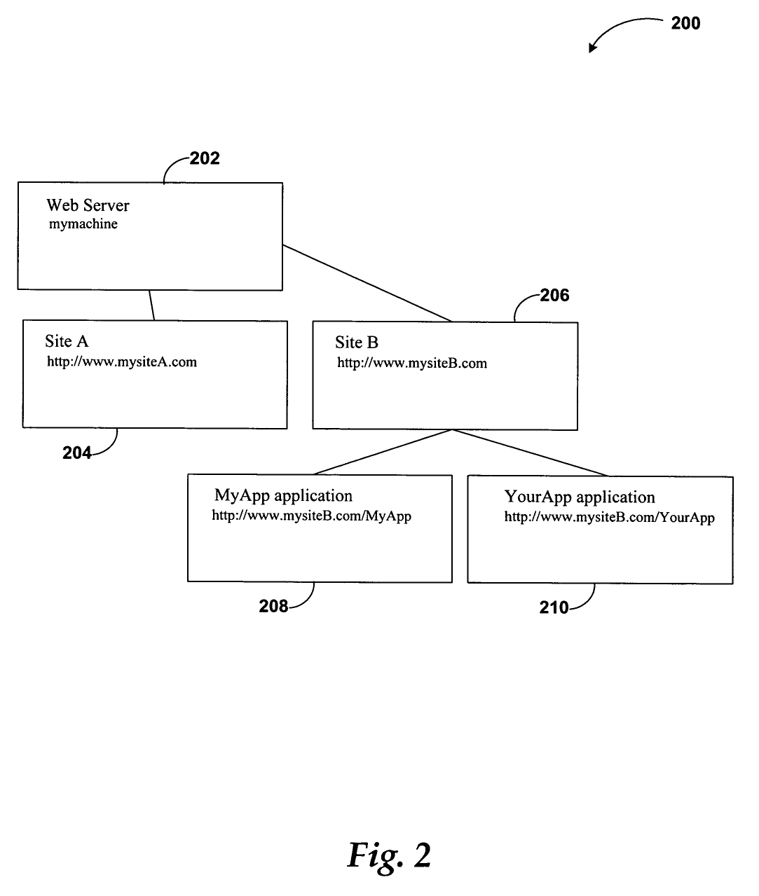

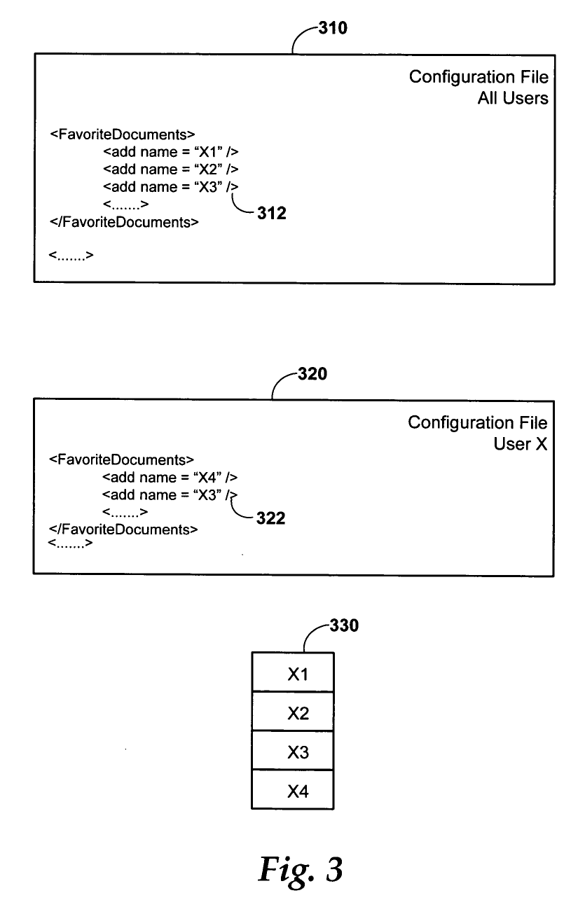

FIG. 2 illustrates an exemplary application hierarchy to which the configuration system of the present invention may be applied. Application hierarchy 200 may comprise any hierarchy of servers, sites, applications, files, and other data structures. Also, application hierarchy 200 may have a static or dynamic hierarchy without departing from the spirit or scope of the present invention. In addition, application hierarchy 200 is only an example of a particular hierarchy (for web applications). Most systems can actually be represented by a hierarchy of configuration nodes, and the application hierarchy discussed herein are not limited to those involving web servers. Any hierarchy may be applicable as determined by the scope to which the settings at each node are applied. For example, FIG. 3 below is an example of a different hierarchy.

Exemplary application hierarchy 200 includes web server 202 as a parent node, site A 204 and site B 206 are child nodes of web server 202, and MyApp 208 and YourApp 210 applications are child nodes of site B 206. The hierarchy may further include directories and files that are children of applications or other nodes without departing from the spirit or scope of the present invention. Configuration properties may be logically applied to each of the nodes at each of the levels of the hierarchy regardless of how the configuration properties are stored (e.g., in a single file, distributed into multiple files, in a database, etc.). Hierarchical semantics may be applied such that settings at a lower node may override settings at a higher node. The semantics may also dictate that certain properties only apply to certain nodes. For example, at the machine level corresponding to web server 202, a security setting may be applied that states that all applications located on the machine are run using a specific user account. A property of this security setting may cause the setting to be persisted down hierarchy 200 so that applications 208 and 210 also have the security setting applied. Other settings may be applied to hierarchy 200 in a similar manner where settings at higher nodes apply default or other settings to applications and files at lower nodes in hierarchy 200.

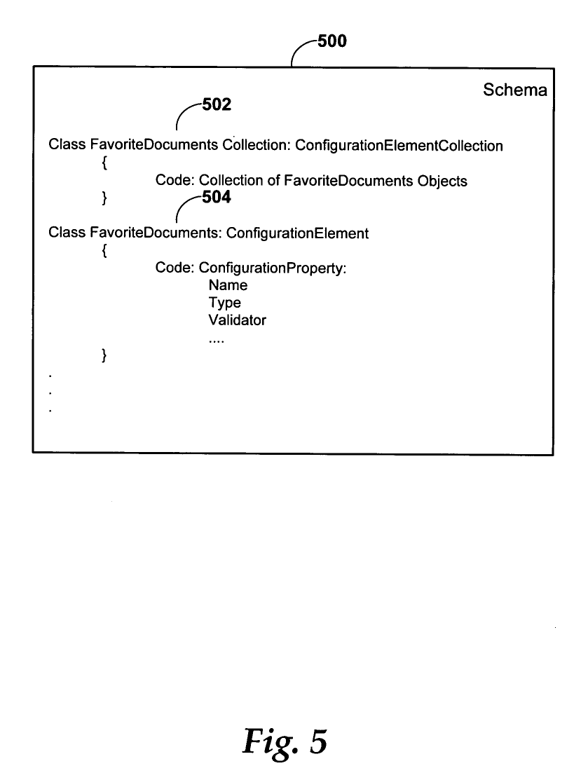

Additionally, lower nodes in the hierarchy may also have their own associated configuration settings. For example, a property may be associated with application 208 that provides window height and width values for the application (see FIG. 5). Furthermore, configuration settings from higher nodes may be overridden at lower nodes. For example, the default setting for a collection of files may be read and write, whereas this setting for a particular file is overridden to make access to the file read only. The delineation between local settings and default settings provides for a hierarchy of configuration settings that corresponds to application hierarchy 200.

Rules may also be applied to the configuration settings at any level according to the object type of the setting. For example, a configuration setting applied at the machine level may have an associated rule that the configuration setting is always inherited and may not be overridden. This type of rule ensures that the configuration setting applies consistently to all children in the hierarchy. A type rule may also be applied. For example, a particular setting may have a rule that the setting is a time unit and therefore must be entered as an interval of time. Additionally, a validation rule may be applied. For example, a setting that is an interval of time may have a rule that states the time interval is required to be within a certain range. If a user or application attempts to set the interval of time outside the accepted range, the setting is considered invalid. Other various rules may be applied to a setting as properties in its associated object type. The number and variety of the properties is not limited to those described herein.

The present invention takes advantage of the object types associated with the settings to allow users or applications to declaratively extend or edit the configuration settings at each level of the hierarchy as necessary. For example, a component may be added at the machine level, or to a particular application. The component may have its own associated set of configuration settings to be applied. Each object type may be associated with one or more settings. Rules for applying/serializing the configuration setting may be declaratively included to declaratively extend the configuration settings of the hierarchy to support the added component.

In one embodiment, the present invention conceptualizes the nodes of hierarchy 200 as documents or files. The document may correspond to an extensible markup language (XML) file or other type of file. In other embodiments, the set of configuration settings may be stored in a database and retrieved to apply the settings to their corresponding component in the hierarchy. In one embodiment, the settings are loaded into their own object in memory. The settings are consolidated or merged with the other configuration settings of the hierarchy according to the inheritance and persistence rules associated with an associated object. The settings are also validated to make sure that the settings conform with any rules or restrictions. Once the configuration settings for a component of the hierarchy are merged and validated, the settings may be applied to the component.

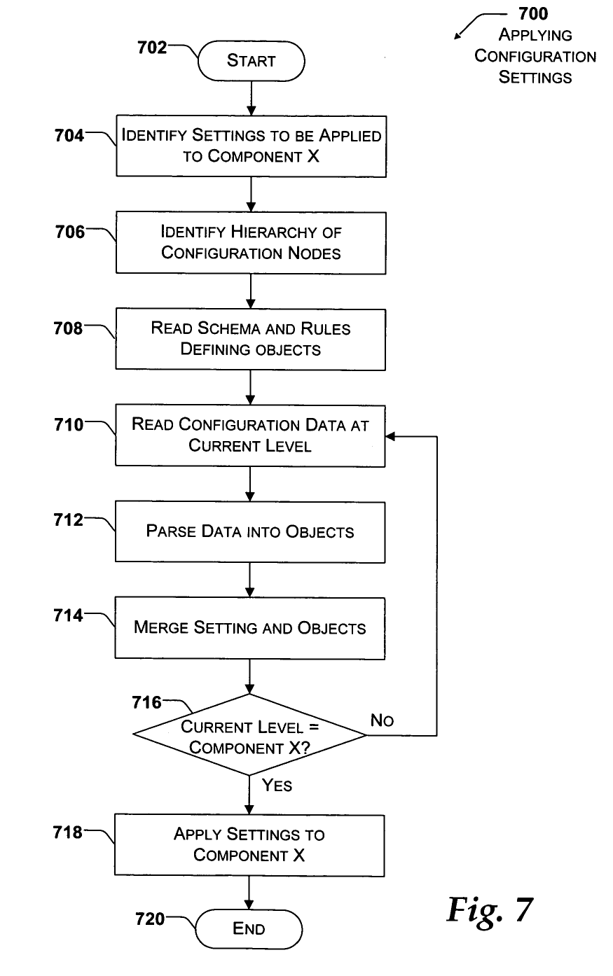

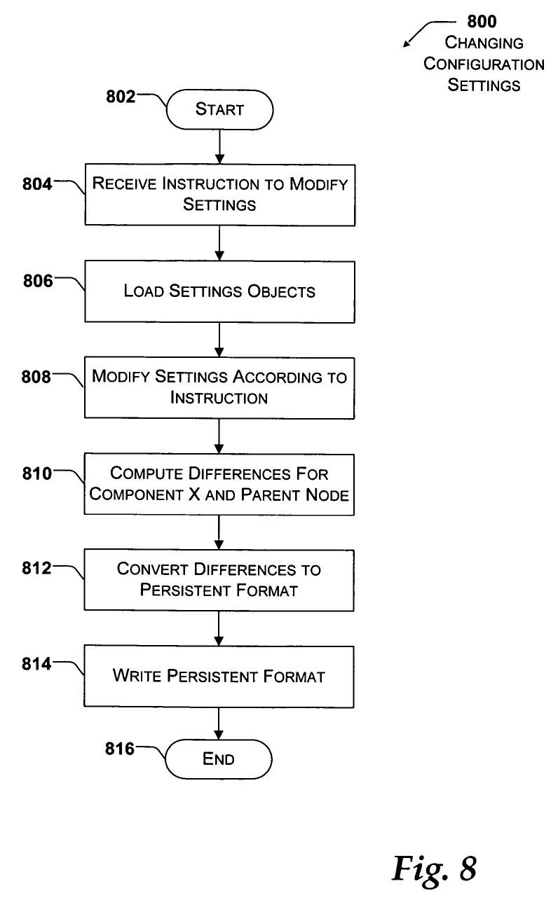

In one embodiment, the present invention may be used to declaratively edit certain lists or collections of items that are persisted amongst the nodes of the hierarchy. For example, a web site such as site 206 may include a global list of shared documents. The global list of shared documents acts as its own component in the hierarchy with its own set of configuration settings. FIG. 7 below describes an exemplary process for applying the configuration settings that provide the global list, while FIG. 8 below describes an exemplary process for modification of the global list.

FIG. 3 illustrates portions of exemplary configuration files associated with an application hierarchy in accordance with the present invention. Configuration files 310 and 320 are exemplary only and do not correspond to actual configuration files used. Only portions of configuration files 310 and 320 are illustrated. Each configuration file may actually contain hundreds or thousands of configuration settings for each level of a hierarchy.

In the present example, the XML included in configuration files 310 and 320 corresponds to the creation of a favorite documents collection that is displayed to a user, as shown by collection 330. Favorite documents collection 330 represents a collection of documents that are of relevance to a user or group. Similar configuration settings may be used to create other collections of documents, files, or data of which a favorite documents list is only one example.

Configuration file 310 adds three documents (X1, X2, X3) to favorite documents collection 330 through a series of add directives (e.g., 312). These documents are added at the all users node in a hierarchy so that they are available to all users. The embodiment shown organizes the configuration hierarchy based on the configuration settings applicable to all users and other configuration settings applicable to individual users (e.g., user X). These settings may also be application or file specific, so that the all users node corresponds to configuration settings for all users of a particular application, or of a particular file. The organization of the hierarchy is therefore not limited to the nodes shown. In the current example, the settings of configuration file 310 have a rule applied that causes the settings to be inherited by lower nodes in the hierarchy. Therefore user X, at a lower node in the hierarchy, inherits the documents added by configuration file 310 into the user's favorite documents collection. In additional embodiments, the settings of configuration file 310 may themselves be inherited from some machine level default settings or other higher level settings (not shown).

Configuration file 320 also adds two documents (X4, X3) to favorite documents list 330. These documents are added at the user X node. Note that the document X3 is added at both the all users node (directive 312), and at the user X node (directive 322). The configuration system of the present invention employs merge semantics to recognize the repeated addition of the document. Accordingly, favorite documents collection 330 includes only one instance of document “X3” despite the two directives (312, 322) both adding document “X3” to favorite documents collection 330.

Favorite documents collection 330 is the result of a merge of the configuration settings of configuration file 310 and configuration file 320. Favorite documents collection 330 corresponds to the user X node such that the collection is displayed through a user interface to user X. Another user may have a different collection according to their individual settings at their own node. However, in this example, each user's collection includes the documents inherited from the all user's node (e.g., documents “X1”, “X2”, “X3”) along with the members of the collection declared at each user's node.

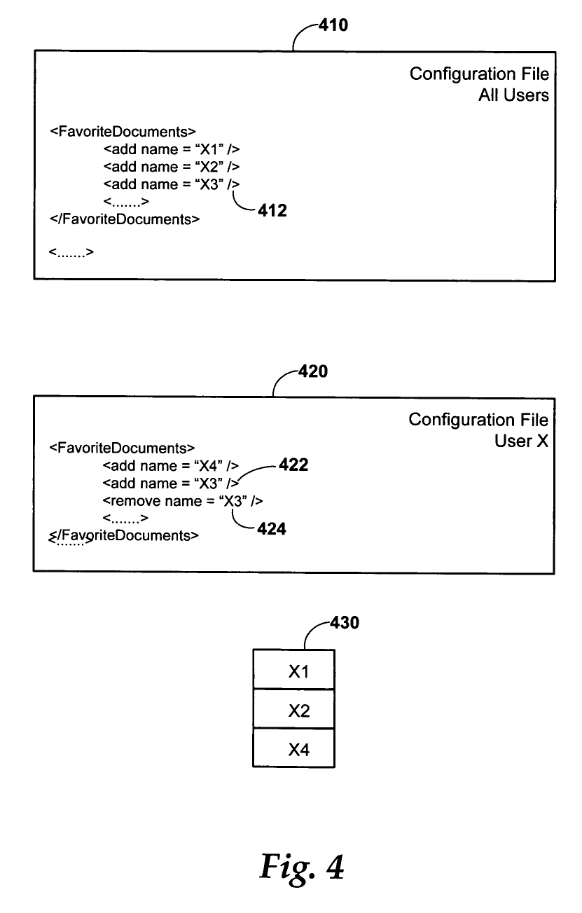

FIG. 4 illustrates another example of portions of exemplary configuration files associated with an application hierarchy in accordance with the present invention.

Similar to FIG. 3, the XML included in configuration files 410 and 420 corresponds to the creation of a favorite documents collection that is displayed to a user, as shown by collection 430. As before, configuration file 410 adds three documents (X1, X2, X3) to favorite documents collection 430 through a series of add directives (e.g., 412). These documents are added at the all users node in a hierarchy so that they are available to all users. Configuration file 420 also adds two documents (X4, X3) to favorite documents list 430. These documents are added at the user X node.

Configuration file 420 also includes a remove directive 424. A problem arises using previous configuration systems when editing or extending a collection such as favorite document list 430. For example, a user may select to delete document “X3” from the collection. Previous configuration systems would require the user to find each instance of the addition of document “X3” in the hierarchy and delete each instance. If add directive 422 were simply deleted at the user X node, document “X3” would not be removed from favorite documents collection 430 at the user X node. Add operation 412 at the all users node is still present persisting document “X3” in the collection. Instead the present invention inserts the remove directive 424 into configuration file 420. The directives are applied to a merged version of favorite documents collection 430. Accordingly, document X3 is declaratively deleted from favorite documents collection 430 as shown. The configuration system of the present invention uses the object definitions to automatically apply the inheritance and merge semantics to ensure that the X3 document is no longer present in the merged result.

Favorite documents collection 430 is therefore the result of a merge of the configuration settings of configuration file 410 and configuration file 420. Favorite documents collection 430 corresponds to the user X node such that the collection is displayed through a user interface to user X. Another user may have a different collection according to their individual settings at their own node with the capability provided by the present invention to add or remove documents from a collection as desired.

FIG. 5 illustrates an exemplary schema that defines a collection in accordance with the present invention. Schema 500 defines two classes of objects, a FavoriteDocumentsCollection object 502 and a FavoriteDocuments object 504 corresponding to the configuration files (310, 320) of FIG. 3. Code is include in each object that provides the properties and rules associated with each object type. For example, in FavoriteDocuments object 504, a set of properties including name, type, and validator are included. The code in each object may vary along with the properties include in each object type.

In accordance with one aspect of the present invention, components of an XML configuration file (e.g., 310 of FIG. 3) are represented in a schema by ConfigurationSection, ConfigurationElement, and ConfigurationProperty classes. Each XML element in the configuration file corresponds to a class that inherits from the ConfigurationElement class. Elements that are configuration sections inherit from the ConfigurationSection class, which itself inherits from the ConfigurationElement class. A configuration element may have one or more configuration properties defined in the schema. Defined properties may be persisted, merged, and validated automatically according to their definition. In one embodiment, properties that are simple types are persisted as attributes of the element while more complex properties are persisted as child elements with their types inheriting from the ConfigurationElement class.

In one example, each configuration property has the following associated information: a name, a type, a default value, a type converter, and a validator. The “name” corresponds to a name used to persist the property. If the property is a child element, the “name” is the name of the element. Otherwise, the “name” is the name of the attribute. The “type” is the datatype of the property. If the property is a child element, this type inherits from ConfigurationElement. The “default value” is the default value of the property, if the property is not present. In one embodiment, the “default value” only applies to attributes. The “type converter” is an object that is capable of converting the property to and from a string. The “validator” is an object that can validate the property value for correctness.

In order to deserialize or serialize a configuration element, the configuration system discovers the collection of properties contained in the element, by examining declarations made by the developer. To examine the declarations, the ConfigurationElement class calls its own Properties member.

The simplest way to declare properties of an element is by creating public properties and attributing them (e.g., with a ConfigurationPropertyAttribute attribute). The following example shows how to mark a property:

[ ConfigurationProperty(“timeout”, DefaultValue=100) ]
public int Timeout {

The base implementation of the ConfigurationElement class inspects property members of the inherited element type. For each property marked with this attribute, the base class creates a ConfigurationProperty instance. The values in the ConfigurationPropertyAttribute are used to construct the ConfigurationProperty. Additionally, the datatype of the property is retrieved from the object datatype.

In one embodiment, properties to be discovered do not have to be public. The class may declare a private property, and still add a ConfigurationPropertyAttribute to persist the property as part of the configuration element.

Each ConfigurationElement object includes a property bag, or collection of property values corresponding to its ConfigurationProperty properties as shown by the collection of properties in FavoriteDocuments class 504.

When reading a configuration setting at the node in which it is declared, the configuration system first creates an instance of this class, and calls a method that enumerates each settings property, and uses the default value metadata of each property to put together the default.

The following example shows a configuration section entered at the machine or root level:

```
<mySettings>
  <add name=”setting1” value=”value1” />
  <add name=”setting2” value=”value2” />
  <add name=”setting3” value=”value3” />
</mySettings>
```

To move this configuration section into the component, the developer provides the following default initialization code. The default intitialization code is only called for objects created at the root level of the hierarchy:

```
public class MySettings : ConfigurationSection {
  protected override void InitializeDefault( ) {
    Settings.Add(new MySettingProperty(“setting1”, “value1”));
    Settings.Add(new MySettingProperty(“setting2”, “value2”));
    Settings.Add(new MySettingProperty(“setting3”, “value3”));
    base.InitializeDefault( );
  }
}
```

When reading the contents of an XML element, the configuration system uses the collection of properties of the element, as described above. For each attribute present in the XML source, the configuration system looks for a corresponding property. If a property is declared, and is not of a type inheriting from ConfigurationElement, the configuration system uses the property information to deserialize the attribute value, and stores it in the element's property bag with the property name. For each child element present in the XML source, the configuration system looks for a corresponding property. If a property is declared, and is of a type inheriting from ConfigurationElement, the configuration system constructs an instance of this type, and deserializes the child element into this new object. Additionally, if there are properties that inherit from ConfigurationElement, those objects are recursively loaded using the same full algorithm as for the parent ConfigurationElement. If no property is found by the given attribute or child name, the configuration system calls a method to handle the unrecognized element. Element classes may override these methods to provide move elaborate handling for attributes or child elements. If a configuration property is declared for the element, but a corresponding attribute or element is not found in the XML source, the configuration system verifies whether the property is required. If it is required, the configuration system throws an exception. If not, it uses a default property to initialize an object with the appropriate default value, and stores this object in the element's property bag. When serializing the contents of a section to an XML file, the configuration system uses the same collection of properties as for deserialization. The configuration system writes out properties that have been created or modified at the current node. As shown in FIG. 3, properties (attributes or elements) inherited from the parent file are not written.

When converting an attribute value from a string to the appropriate type or vice versa, the configuration system uses a string conversion mechanism. This mechanism has built in conversion support for strings, integers, doubles, booleans, and enumerators. For other types, the configuration system looks for an appropriate converter to convert the type to and from a string. Default merge behavior of the ConfigurationElement class is implemented by selected merge semantics. In one embodiment, when an attribute property is present at the current node, its value overrides any inherited value. Otherwise, if the current node has a parent node, the value is inherited from the value of the same property at the node level. If the current node has no parent, the default value of the property is used. If a child element property is present at the current node, its attributes and properties are merged by recursively applying these same rules.

For example, if a parent node contains the following section:

```
<mySettings timeout=”0” id=”myID”>
  <settingsStore name=”foo” />
  <moreSettings value=”100” />
</mySettings>
```

And the current node contains the following section:

<mySettings id=”myNewID”>
<settingsStore id=”bar” />
</mySettings>

The merged result is the following (assuming all the attribute and section properties are valid):

```
<mySettings timeout=”0” id=”myNewID”>
  <settingsStore name=”foo” id=”bar” />
  <moreSettings value=”100” />
</mySettings>
```

When deserializing a property, the configuration system is able to validate the property for correctness. When the configuration system implicitly loads configuration at runtime, it automatically validates its contents and throws an exception if validation fails. However, the developer may also explicitly call a validate method on a configuration, which returns true or false. To validate a property, the developer must associate a validator with the property. An example validator may be one that validates string properties to ensure they are non-empty. Another example validator may be one that validates integer properties to ensure they fall within the specified range.

Collections of configuration settings are represented in the object model by a ConfigurationElementCollection class. A developer may create a class that inherits from this base class, and override specific members to indicate collection behavior and contents. The base class provides support for persistence and merging. To create a collection class, the developer creates a new class (e.g., Favorite Documents 504), that inherits from ConfigurationElement and represents a single element of the collection. Properties are then added to FavoriteDocuments and marked as attributes. A new class is created (e.g., FavoriteDocumentsCollection 502) that inherits from ConfigurationElement Collection class. A new instance of FavoriteDocuments is returned as well as an object representing a key for each element of the collection. A persistence model is then selected for the collection such as an add/remove/clear model. For example, when dealing with a collection such as FavoriteDocumentsCollection, a user may be provided with the ability to create directives such as add, remove, etc. for take parameters and/or return values of type FavoriteDocuments. These directives are included in the inherited class, and call the general base methods (BaseAdd, BaseGet, etc.) to use functionality in the base class.

A collection of settings values is usually keyed by some value or values, rather than simply indexed. The key is used to look up entries through the object model. For example, a collection of HTTP handler mappings is keyed by the filetype and method.

Keys of a collection are simply treated as special properties (e.g., collection key properties) of each element of the collection. In one embodiment, the ConfigurationElement class allows developers to declare collection key properties of an element.

To support modification in a hierarchical configuration system, collections support the ability to add, remove, modify, or clear entries in a collection. An exemplary process for modifying a configuration setting is described below with relation to FIG. 7. In the configuration XML format, each XML element of the collection is actually an instruction on how to modify the collection. For example, if the parent configuration specifies the following section:

```
<portMappings>
  <add port=”80” handler=”HttpMappingHandler” />
  <add port=”8080” handler=”HttpMappingHandler” />
</portMappings>
```

And the child configuration specifies the following section:

```
<portMappings>
  <remove port=”8080” />
  <add port=”5” handler=”SmtpMappingHandler” />
</portMappings>
```

The merged result is as follows:

```
<portMappings>
  <add port=”80” handler=”HttpMappingHandler” />
  <add port=”5” handler=”SmtpMappingHandler” />
</portMappings>
```

The ConfigurationElementCollection class supports such a model for specifying a collection, and automatically applies the necessary merge and serialization semantics so that the object model allows the user to work with the merged collection.

The following table describes exemplary operations on an add/remove/clear collection, and how they affect persistence:

TABLE 1

| Operation | Persisted XML |
|---|---|
| Add a new element to the | <add key value /> |
| collection | |
| Modify an element inherited | <remove key /> |
| from the parent | <add key value /> |
| Modify an element declared | Replace value in the current <add> |
| at this node | entry |
| Remove an element inherited | <remove key /> |
| from the parent | |
| Remove an element declared | Remove the current <add> entry |
| at this node | |
| Clear the collection | <clear /> |
| | Elements added after clearing the |
| | collection are persisted as <add> entries |

The above exemplary operations are exemplary only and should not be construed to limit the spirit or scope of the invention.

In an additional embodiment, a lockdown property may be associated with a particular object type. The lockdown property prevents the configuration settings associated with that object type from being modified or deleted from the node in which it is declared and any node that inherits the configuration setting. The lockdown property is a useful property to ensure that certain configuration settings maintain their integrity throughout applications and files.

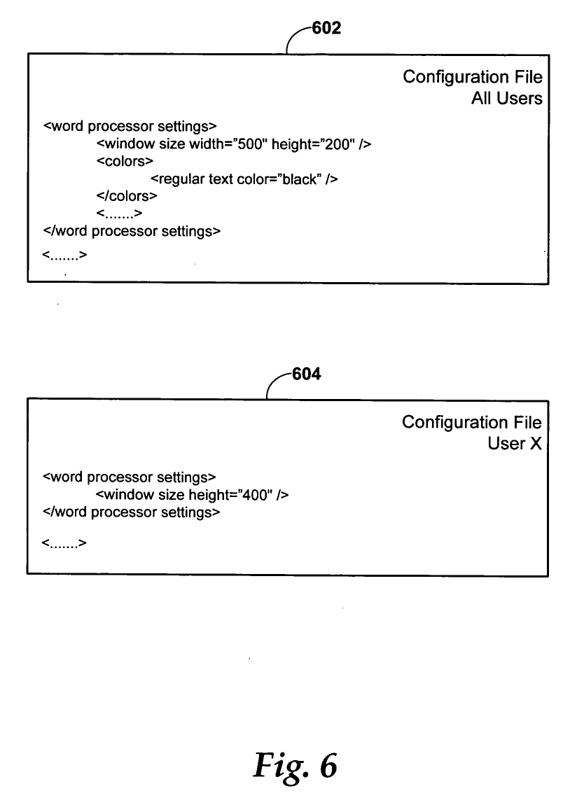

FIG. 6 illustrates portions of an additional exemplary configuration files associated with an application hierarchy in accordance with the present invention. Configuration files 610 and 620 are exemplary only and do not correspond to actual configuration files used. Configuration files 610 and 620 also represent only portions of a configuration file that each may contain hundreds or thousands of configuration settings for each level of the hierarchy.

Configuration files 610 and 620 illustrate another example of the hierarchical organization of configuration settings. Configuration file 610 corresponds to an all users level of a hierarchy while configuration file 620 corresponds to settings that apply to a single user, user X. The portion of configuration file 610 shown contains settings for a word processor application. The settings include a window size setting and a color setting. The window size setting includes width and height values while the color setting includes further embedded settings such as regular text color.

In the current example, the settings of configuration file 610 have a rule applied that causes the settings to be inherited by lower levels in the hierarchy. Configuration file 620 includes an override of one of these inherited configuration settings. As shown, the configuration settings inherited at the user X level are not restored at the user level. Instead, the configuration settings stored at the user X level merely correspond to individual settings for the user. In this case, the setting shown changes the window size height value to “200” from “400”. The change of this setting is assisted by the present invention as described above with relation to FIGS. 3-5. Instead of an addition to a collection however, the present example illustrates a change to setting value, or an edit of a setting. Again, the edit shown may be performed declaratively by user in accordance with the present invention. A user simply enters the change in a user interface field or as an entered statement and the configuration system adds the declaration shown at the user level. The configuration system of the present invention maintains then applies the inheritance and persistence rules of the hierarchy transparently to the user.

FIG. 7 is a logic flow diagram illustrating an exemplary process for applying configuration settings in accordance with the present invention. Process 700 starts at block 702 where an application hierarchy has associated configuration settings that are to be applied. Processing continues at block 704.

At block 704, the settings to be applied to component X are identified. The settings may be identified according to the directives included in the configuration files of the hierarchy. A configuration file is present for each of the nodes (e.g., levels) in the hierarchy. The configuration settings to be applied to component X may therefore be identified. Processing continues at block 706.

At block 706, the hierarchy of configuration nodes to be applied to component X are identified. The hierarchy of nodes may include the root node of the hierarchy down to the node corresponding to component X. Each node needs to be accounted for since a configuration setting may be inherited at a node from a directive located at a higher node in the hierarchy. For example, in FIG. 3 a directive stating “<add name=“X3”/>” is inherited at the user X node from the all users node. Another directive also stating “<add name=“X3”/>” is included at the user X node. Both directives are considered to be associated with the user X node even though when merged, user X observes only one instance of document X3 due to the merge semantics. Once the hierarchy of configuration nodes applicable to component X are identified, processing continues at block 708.

At block 708, the schema and rules defining the objects for the identified configuration settings is read into memory. In one embodiment, multiple schemata and rules may apply to a group of configuration settings and their associated directives. As previously stated, the schema defines the objects related to the configuration rules that apply to component X. Once the schema is read into memory, process 700 continues at block 710.

At block 710, the configuration data from the persisted format is read at the current level. The first level read at block 710 is the root level of the hierarchy applicable to component X. The persisted format corresponds to the format of directives for the configuration settings that is persisted throughout the hierarchy to lower levels. For example, the configuration settings at the root level may add a document and then remove the document within the same set of settings. The persisted format of the configuration settings therefore does not include the document since it was removed after it was added. Once the configuration data is read at the current level, processing continues at block 712.

At block 712, the configuration data corresponding to the directives at the current node are parsed into the objects of the schema. By reading the configuration settings into the objects, the properties associated with each of the configuration settings is determined. For example, when the directives of FIG. 3 are read into the objects of the schema in FIG. 5, the configuration system determines that the directives are part of a favorite documents collection and each directive corresponds to an operation related to a favorite document in that collection. For instance, the directive “<add name=“X3”/>” adds a favorite document “X3” to the favorite document collection. Furthermore, the properties of favorite documents elements and the favorite documents collection elements are discovered as part of the schema. For example, a favorite documents element may be an element that is always inherited, validated when the value is a non-null character string, and keyed according to its name. These and other properties of the elements are discovered when the configuration settings are parsed into the objects. An object may have any number of associated properties. The properties declaratively define rules for the configuration settings including how these configuration settings are persisted, inherited, validated, merged and the like. This avoids having to manually apply these rules on a directive-by-directive basis throughout the hierarchy. The rules are applicable to the configuration settings throughout the hierarchy and are simply declared in the associated objects of the configuration settings. The declarative nature of the properties associated with the configuration settings allows a developer of the component to which the configuration settings apply to simply declare these properties in the object and leave the application of these properties to the configuration system. Once the configuration settings are parsed into their associate objects, processing continues at block 714.

At decision block 714, the settings objects at the current level are merged with the settings object of the parent level. If the current level is the root level, then no parent level is available, so a merge does not occur. However, for the other level the settings are merged with their parent level. Therefore, as the merge takes place between the current level and parent level the persisted format of the configuration settings is updated. For example, a document added at the parent level may be removed at the current level. The persisted format of the configuration settings provided to a child level of the current level therefore does not include the document. Once the settings objects are merged, processing continues at decision block 716.

At decision block 716, a determination is made whether the current level of the hierarchy where configuration data was just processed corresponds to component X. If the current level is not the level of component X, processing returns to block 710 where process 700 continues to process the configuration settings at each level of the hierarchy. However, if the current level does correspond to component X, processing continues to block 718.

At block 718, the configuration settings are applied to their corresponding component or application transparently to a user or the developer of the component or application. The properties of the related configuration settings at a particular node are declared in the object, making it unnecessary for a user or developer to oversee the application of the properties. The configuration system, based on the related objects and properties of the configuration settings, transparently applies the persistence, inheritance, validation, merging, and other rules to the configuration settings. The configuration settings are therefore applied to their corresponding component or application in accordance with these rules without manual intervention by a user or developer. Once the configuration settings are applied, processing continues to block 720 where process 700 ends and processing continues to other tasks.

Process 700 is an example embodiment for illustration purposes. The invention is not limited to the flowchart blocks or the order of blocks of process 700. Other embodiments of the present invention may be implemented in another process with fewer or additional blocks and in other orders without departing from the scope and spirit of the invention.

FIG. 8 is a logic flow diagram illustrating an exemplary process for modifying configuration settings in accordance with the present invention. Process 800 starts at block 802 configuration settings are already applied to an application hierarchy and a user or developer decides to modify one or more of the settings. Processing continues at block 804.

At block 804 the configuration systems receives the instruction to modify one of the configuration settings based on an input from a user, client application, or developer. For example, a user may select a configurations tab and enter a modification into a configuration field. In another example, a user may select a profile that modifies a number of different configuration settings of an application. The application then provides the modification instructions according to the profile selected. Any configuration setting may be modified. Using the example of FIG. 4, a user may desire to remove the document “X3” from their favorite documents collection at the user X node. To make this modification two directive need to be overridden. A first directive stating “<add name=“X3”/>” is inherited at the user X node from the all users node. Another directive also stating “<add name=“X3”/>” is included at the user X node. Other instructions may also be provided such as add or edit for a particular configuration setting. Once the instruction for modifying the configuration settings is received, processing continues at block 806.

At block 806, the settings objects associated with the component to be modified (e.g., component X) to be modified is loaded as described above with respect to process 700. The properties associated with the configuration settings are therefore discovered as described above. The configuration system therefore knows the rules applied to the configuration setting by opening the instance of the object for the configuration setting. For example, with relation to FIG. 4 the configuration system knows that the favorite documents element is an object that may be inherited from higher nodes in the hierarchy. Process 800 continues at block 808.

At block 808, the loaded settings objects are edited according to the instructions provided. The edit to the configuration objects results in configuration settings applied to component X that are different than those previously applied. However, the change in the configuration object does not yet take into account the settings of other levels of the hierarchy. Processing continues at block 810.

At block 810, the differences between the settings objects applicable to component X and the settings objects applicable to the parent level of component X are computed. The differences are computed using the rules discovered in process 700 when the schema and rules were loaded into memory. For example, in FIG. 4 the directive “<add name=“X3”/>” adds a favorite document “X3” to the favorite document collection. The directive is repeated at both the all users node and the user X node. If an instruction directs the configuration system to remove document “X3” from the favorite documents collection at the user X node then a difference exists between the all users node (e.g., the parent level) and the user X node (e.g., the component X level) that may be computed. Once the difference is computed, processing continues at block 812.

At block 812, the differences discovered between a parent level and the component X level is converted to a persistent format for the configuration settings at that level. For example, a persistent format for removing document “X3” of FIG. 4 would not correspond to a format that simply deletes the add document directive at the user X node. Instead the present invention is able to generate a persistent format for the configuration settings that takes into account the inherited settings from previous levels of the hierarchy. In the example, of FIG. 4 the persistent format corresponds to a directive stating “<remove name=“X3”/> that is entered after the add directives to remove the document from the collection. Once the differences between the settings objects of the parent level and the current level are converted to a persistent format, processing continues at block 814.

At block 814, the persistent format for the settings including the differences is written into the configuration file. For example, in FIG. 4 the “<remove name=“X3”/> directive is written into the configuration file at the user X node. Due to the declarative nature of the configuration system in the present invention, the “<remove name=“X3”/> is applied to the merged result of the configuration setting. Since the remove directive applies to the merged result, both instances of the “<add name=“X3”/>” directive are accounted for by the configuration system. The resulting favorite documents collection does not therefore include document “X3”. This is different from previous configuration systems where each instance of the “<add name=“X3”/> directives would need to have been manually found in order to account for them and remove document “X3” from the collection. In the present invention, the properties in the objects of the configuration setting declaratively define rules for the configuration setting including how the configuration setting are persisted, inherited, validated, merged and the like. This avoids having to manually apply these rules on a directive-by-directive basis throughout the hierarchy or edit the configuration hierarchy node-by-node. The rules are applicable to the configuration settings throughout the hierarchy so that modifications are simply entered into a configuration file, letting the configuration system account for the inheritance rules and other semantics. After the persistent format is entered into the configuration file to institute the modification, processing continues at block 816 where process 800 ends and processing advances to other tasks.

Process 800 is an example embodiment for illustration purposes. The invention is not limited to the flowchart blocks or the order of blocks of process 800. Other embodiments of the present invention may be implemented in another process with fewer or additional blocks and in other orders without departing from the scope and spirit of the invention.

It is appreciated that the above described invention may be applicable to more than just configuration settings. The present invention may be extended to include any attribute applied to applications, files, and the like in a hierarchical structure. The present invention allows these attributes to be set and edited declaratively, insulating a user from being required to know the underlying structure of the hierarchy.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for providing a hierarchical configuration system, comprising:
associating a schema with a configuration hierarchy, wherein the configuration hierarchy corresponds to configuration settings applied to an application hierarchy;
associating an object type in the schema with a configuration setting of the configuration hierarchy, wherein the object type declaratively defines a set of properties applicable to the configuration setting; and
transparently applying the configuration settings to the application hierarchy in accordance with the set of properties declaratively defined in the object type.

2. The computer-implemented method of claim 1, further comprising identifying configuration setting directives to determine the object type of the schema associated with the configuration setting of the configuration hierarchy.

3. The computer-implemented method of claim 1, wherein transparently applying the configuration settings further comprises applying validation rules to the configuration settings while insulating the user from the validation process.

4. The computer-implemented method of claim 1, wherein transparently applying the configuration settings further comprises applying inheritance rules to the configuration settings while insulating the user from the inheritance semantics.

5. The computer-implemented method of claim 1, wherein transparently applying the configuration settings further comprises applying merge semantics to the configuration settings while insulating the user from the merge process.

6. The computer-implemented method of claim 1, wherein each node in the configuration hierarchy is configured with an associated configuration file.

7. The computer-implemented method of claim 6, wherein directives for applying the configuration settings at a node are included in the configuration file.

8. The computer-implemented method of claim 7, wherein each directive of the configuration file is associated with a particular object type of the schema.

9. The computer-implemented method of claim 6, wherein the configuration file is an eXtensible Mark-up Language (XML) file.

10. The computer-implemented method of claim 1, wherein the set of properties includes a lockdown property.

11. The computer-implemented method of claim 1, wherein the object type defines a collection of configuration settings.

12. The computer-implemented method of claim 1, further comprising modifying a configuration setting by declaratively applying the modification to a merged result of the configuration hierarchy for a particular node.

13. A computer-readable medium having computer-executable instructions thereon arranged to provide a hierarchical configuration system, the computer-executable instructions comprising:
identifying configuration setting directives stored in a configuration file, wherein each node of a configuration hierarchy has an associated configuration file;
associating a schema with the configuration hierarchy, wherein the configuration hierarchy corresponds to configuration settings applied to an application hierarchy;
associating an object type in the schema with a configuration setting of the configuration hierarchy, wherein the object type declaratively defines a set of properties applicable to the configuration setting; and
transparently applying the configuration settings to the application hierarchy in accordance with the set of properties declaratively defined in the object type.

14. The computer-readable medium of claim 13, wherein transparently applying the configuration settings further comprises applying validation rules to the configuration settings while insulating the user from the validation process.

15. The computer-readable medium of claim 13, wherein transparently applying the configuration settings further comprises applying inheritance rules to the configuration settings while insulating the user from the inheritance semantics.

16. The computer-readable medium of claim 13, wherein transparently applying the configuration settings further comprises applying merge semantics to the configuration settings while insulating the user from the merge process.

17. The computer-readable medium of claim 13, wherein each configuration setting directive of the configuration file is associated with a particular object type of the schema.

18. The computer-readable medium of claim 13, further comprising modifying a configuration setting by declaratively applying the modification to a merged result of the configuration hierarchy for a particular node.

19. A hierarchical configuration system, comprising:
a computing device;
a memory having stored thereon data structures for implementing the configuration system, the data structures comprising:
an application hierarchy, wherein the application hierarchy provides a logical inheritance relationship among applications and components;
configuration files corresponding to each node of the application hierarchy, wherein the configuration files include directives for applying configuration settings to the application hierarchy; and
a schema, wherein the schema includes object types corresponding to the directives of the configuration files and an object type in the schema is associated with a configuration setting of the configuration hierarchy and the object type declaratively defines a set of properties applicable to the configuration setting such that the configuration settings are transparently applied to the application hierarchy in accordance with the set of properties.

20. The system of claim 19, wherein the configuration settings are modified by declaratively applying the modification to a merged result of the configuration hierarchy for a particular node.
